(19) United States
(12) Patent Application Publication
(10) Pub. No.: US 2020/0244604 A1
(43) Pub. Date: Jul. 30, 2020

(54) APPLICATION PROGRAM INTERFACE DOCUMENTATIONS

(71) Applicant: Hewlett Packard Enterprise Development LP, Houston, TX (US)

(72) Inventors: Alexander Mejias, Durham, NC (US); Jesse D. Olsen, Fort Collins, CO (US); Jeroen Kleen, Amstelveen (NL); Dana Lynn, Fort Collins, CO (US)

(21) Appl. No.: 16/262,469

(22) Filed: Jan. 30, 2019

(51) Int. Cl. H04L 12/58; H04L 29/08; G06F 17/27

(52) U.S. Cl. CPC H04L 51/02; G06F 17/2705; H04L 67/02

(57) ABSTRACT

An example system including a processing resource and a memory resource. The memory resource may store machine-readable instructions to cause the processing resource to, responsive to receiving an input at a chatbot, parse a documentation configuration reference of an API for a regular expression, declared in the API documentation configuration reference, matching a portion of the input. The memory resource may store machine-readable instructions to cause the processing resource to execute an action according to a mapping declared by the documentation configuration reference of the API as corresponding to the regular expression matching the portion of the input.

### BACKGROUND

A chatbot may include an application that simulates a conversation with users. The chatbot may provide a service to a user and communicate in a conversational style with the user in providing the service. The chatbot may accept natural language text and/or voice inputs from the user. The chatbot may generate and output natural language text and/or voice output to the user. The chatbot may be architecturally and functionally separate from other applications but the chatbot may be utilized to interface with the other applications.

### BRIEF DESCRIPTION OF THE DRAWINGS

FIG. 1 illustrates an example of a system of API documentation configuration reference utilization consistent with the present disclosure.

FIG. 2 illustrates an example of a system of API documentation configuration reference utilization consistent with the present disclosure.

FIG. 3 illustrates an example of a system of API documentation configuration reference utilization consistent with the present disclosure.

FIG. 4 illustrates an example of a non-transitory machine-readable memory resource and processing resource of API documentation configuration reference utilization consistent with the present disclosure.

FIG. 5 illustrates an example of a method of API documentation configuration reference utilization consistent with the present disclosure.

### DETAILED DESCRIPTION

A chatbot may be utilized to provide a service to a user. The chatbot may be a stand-alone application that utilizes and/or interfaces with other applications to provide the service to the user. A chatbot may include non-transitory machine-readable instructions executable by a processor to provide the service to the user. The chatbot instructions may be separate and stand apart from instructions of the applications that the chatbot utilizes and/or interfaces with to provide the service to the user.

A chatbot may interface with an application. For example, a chatbot may be utilized to communicate with an application programming interface (API) of an application that is distinct from the chatbot. In some examples, the chatbot may perform communications such as issue commands to a separate application and/or receive outputs from a separate application. As such, a chatbot may be configured to communicate with an API of a separate application.

The chatbot may operate as a component of or as a stand-alone digital assistant. For example, the chatbot may function to convert user input to the chatbot into commands to an API of a separate application. The chatbot may also communicate outputs from the API of the separate application to the chatbot user through the chatbot interface, such as a web chat application interface visible to users.

However, chatbots may be configured to communicate in a conversational style with their users. For example, chatbots may be configured to accept natural language text and/or voice inputs from a user and/or output data to the user in an approximation of a natural language format. In contrast, the separate applications that the chatbot interfaces with to send and/or receive data associated with performing digital assistant functionalities on behalf of the user may not respond to and/or understand communications and/or commands in a natural language format.

In order to facilitate chatbot communication with a separate application, the chatbot will be hardcoded with instructions executable to perform the specific communications with the specific separate application. For example, a chatbot may be extended with a software developer kit (SDK) such as a library of code added to the chatbot that specifies regular expressions that may be identified in the input to the chatbot along with the corresponding objects and commands that should be generate by the chatbot in order to effectuate an operation or response at the specific separate application. In order to communicate with multiple separate applications, the chatbot may be extended with multiple different libraries each corresponding to a separate API. As such, each additional API and/or each new API that it may be desired for the chatbot to communicate with may involve an additional extension and/or update of the chatbot.

In contrast, examples of the present disclosure may include chatbots that may be able to receive and transform regular language inputs received from a user to actionable outputs understandable by a plurality of different APIs without a corresponding plurality of extensions to the chatbot hard coding in such transformations to the chatbot. Likewise, examples of the present disclosure may be able to transform outputs from the API into natural language outputs presentable to the user by the chatbot, again without the corresponding plurality of extensions to the chatbot hard coding in such transformations to the chatbot. For example, examples of the present disclosure may include a system including a processing resource and a memory resource. The memory resource may store instructions executable by the processing resource to perform various functionalities. For example, the instructions may be executable by the processing resource to responsive to receiving an input at a chatbot, parse a documentation configuration reference of an API for a regular expression, declared in the API documentation configuration reference, matching a portion of the input; and execute an action according to a mapping declared by the documentation configuration reference of the API as corresponding to the regular expression matching the portion of the input.

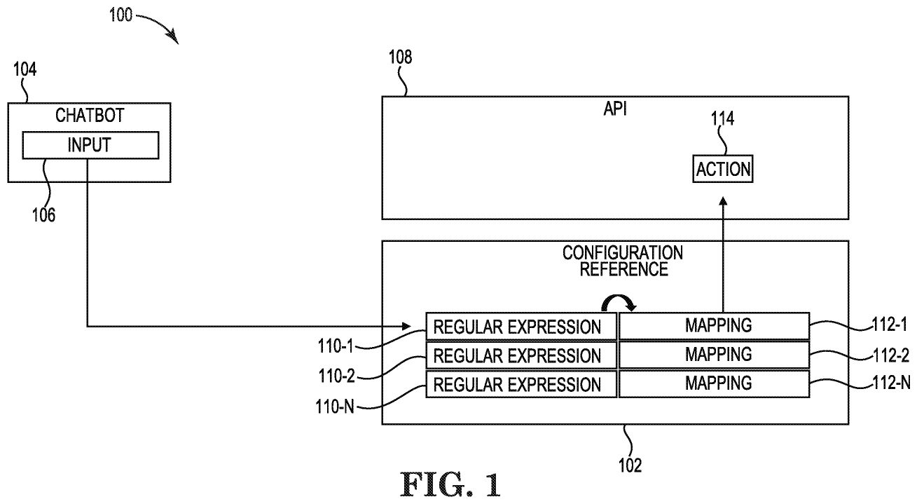

FIG. 1 illustrates an example of a system 100 of API documentation configuration reference 102 utilization consistent with the present disclosure. The system 100 may include a chatbot 104. The chatbot 104 may provide a digital assistant service to a user. The chatbot 104 may be accessible via a web application. For example, a user may access the chatbot 104 and/or utilize its services via user interface presented to the user via a web application presented on a user's computing device.

The chatbot 104 may accept input 106 from a user. The input 106 may be text and/or voice fed into the user interface of the chatbot 104 from a user. The chatbot 104 may be configured to communicate with the user in a conversational manner. For examples, the chatbot 104 may accept input 106 in a natural language format and/or generate outputs to the user in a natural language format. For example, a user may type or speak information to the chatbot 104 formatted in human language of whichever dialect the user is familiar with. In examples, the input 106 may be structured in sentence form. That is, in contrast to a constructed or formal language such as those used to program computers or to study logic, an input 106 may be structured as an English language command, instruction, request, question, etc. written or spoken in a natural ordinary human language.

In an example, the input 106 may include a natural language expression of an instruction to the chatbot 104 to perform a functionality on behalf of the user. In this manner, the chatbot 104 may serve in a digital assistant capacity. For example, the input 106 may include a sentence such as “show me everyone's phone number on the project A team.” However, the chatbot 104 may not be the application and/or a component of the application that has access to the data and/or services being requested by the user. For example, the chatbot 104 may be a stand-alone digital assistant that is not part of the APIs that the user is requesting in their input 106 to be accessed and/or manipulated.

In an example, a user may be an information technology (IT) specialist for a company. The user may desire to utilize the chatbot 104 to interface with project management APIs, cloud management platform APIs, blade enclosure management APIs, etc. The chatbot 104 may be a separate generic chatbot that may not be a component of any of the APIs. However, the input 106 from the user to the chatbot 104 may implicate data to be retrieved from, a command to be issued to, a functionality to be performed by, etc. the separate APIs. For example, the “show me everyone's phone number on the project A team” input 106 may be a natural language expression tantamount to a command to the chatbot 104 to communicate with the project management API and retrieve everyone's phone number on the project A team from that API and present it to the user. However, chatbot 104 may not include a hard-coded extension serving as a library at the chatbot 104 that, when referenced, provides the chatbot 104 with the instructions utilizable to communicate the intent of the input 106 to the project management API in a format understandable to and/or actionable by the project management API.

As described above, the system 100 may include an API 108. The API 108 may include a single API and/or a plurality of APIs. The API 108 may include instructions executable by a processing resource to receive requests and/or send responses from an underlying application and/or group of resources. The API 108 may include instructions executable to facilitate communication between two systems by providing a language and/or contract for how two systems interact.

The API 108 may be separate and/or stand-alone from the chatbot 104. For example, the API 108 may be a project management API, a cloud management platform API, blade enclosure management API, etc. The API 108 may control and set the terms of access to underlying resources related to project management, a cloud management platform, blade enclosure management, etc. While a chatbot 104 may utilize the API 108 to interface with said resources, the chatbot 104 may be functionally and/or architecturally distinct from the API 108 and the underlying resources.

The API 108 may include a configuration reference 102. A configuration reference 102 may include a computing file specifying the configuration of the API 108 and its use. For example, the configuration reference 102 may include a component of, provided by, and/or associated with the API 108 that is accessible to and/or readable by users and/or the chatbot 104.

For example, the configuration reference 102 may be a portion of an API's documentation file. The API documentation configuration reference 102 may include documentation that serves as a reference manual for the API 108. The API documentation configuration reference 102 may communicate to API consumers how to utilize the API 108. The API documentation configuration reference 102 may be structured for consumption by humans. The API documentation configuration reference 102 may provide examples of every call, every parameter, and responses for each call for the API 108. The API documentation may include code samples for commonly used languages such as, for example, Java, JavaScript, PHP, Python, etc. API documentation may provide explanations for each API request and examples of error messages. The API documentation may communicate functional knowledge of the API 108. That is, the API documentation may include an explanation of how an API 108 functions and how to call those functions. The API specification may detail the functional and expected behavior of the API as well as the fundamental design philosophy and supported data types. An API definition may be similar to an API specification in that it provides an understanding of how an API is organized and how the API functions. However, the API definition may be structured for machine consumption instead of human consumption and may provide information about how the API functions, how it links with other APIs, and the expected results in a machine-readable format.

Documentation configuration references 102 may include a Swagger file or other configuration file. The documentation configuration reference 102 may include information that may be utilized as a map of how the API 108 is organized and/or functions for reference by developers developing against it. The documentation configuration reference 102 may be structured in a variety of formats. For example, the documentation configuration reference 102 may be structured to include OpenAPI definitions in YAML or JSON, however examples are not so limited. The documentation configuration reference 102 may include information such as title, description, and version information for the API 108. The documentation configuration reference 102 may include information such as the API server and/or base URL for the API 108. The documentation configuration reference 102 may include API paths relative to the server URL for the API 108. For example, the documentation configuration reference 102 may include information that defines individual endpoints and/or paths to endpoints in the API 108 and/or the HTTP (or other standard) methods or operations supported by the endpoints. The operations may be defined by information including parameters, request body, if any, possible response status codes, response contents, etc. The operations may have parameters passed via URL path, query string, headers, cookies, etc. The documentation configuration reference 102 may include information including input and output models described with global components/schemas for common data structures utilized in the API 108 that can be references whenever a schema is to be utilized. The documentation configuration reference 102 may include security schemas and security keywords that may be used to describe the authentication methods utilized in the API 108.

Examples of the present disclosure may extend and/or transform existing documentation configuration references 102. For example, the documentation configuration reference 102 of an API 108 may be modified. The documentation configuration reference 102 of API 108 may be modified to include language feature identifiers. Language feature identifiers may include various mechanisms for identifying, translating, understanding, and/or matching structures or patterns present in natural language inputs. For example, the language feature identifiers may include natural language structures stored in the documentation configuration reference 102. That is, the language feature identifiers may include natural language structures that may be compared to a natural language input to identify matching structures in the input. As such, the language feature identifiers may serve as a list of potential natural language structure which may appear in a natural language input, in order to contextualize and understand the information and/or intent that the user inputting the natural language input is attempting to communicate. The language feature identifiers may help make sense of a natural language input by identifying structures or patterns that may be associated with different meanings or commands.

Examples of a language feature identifiers may include regular expressions 110-1 . . . 110-N. For example, a regular expression 110-1 . . . 110-N may include specialized notations for describing language patterns that may be matched and/or identified in a natural language input 106. The regular expression 110-1 . . . 110-N may include characters, strings of characters, punctuation, wildcard symbols, alternatives symbols, group strings, forced match symbols, optionality symbols, character range symbols, etc. that describe language patterns that may be matched and/or identified in a natural language input 106. The regular expressions 110-1 . . . 110-N may be utilized as a catalog of characters that when matched to a portion of the natural language input 106 may identify or categorize a meaning or context of the natural language input 106.

Again, these regular expressions 110-1 . . . 110-N may be stored as a portion of the documentation configuration reference 102 of the API 108. That is, in contrast to other chatbots which may include regular expression catalogs as libraries that are extension of the instructions or code of the chatbot itself, the regular expressions 110-1 . . . 110-N may be a component of the documentation configuration reference 102 and/or the API 108.

In addition to the regular expressions 110-1 . . . 110-N, the documentation configuration reference 102 may include mappings 112-1 . . . 112-N. The mappings 112-1 . . . 112-N may correspond to a portion of the regular expressions 110-1 . . . 110-N. For example, a first mapping 112-1 may correspond to a first regular expression 110-1 . . . 110-N. Each mapping 112-1 . . . 112-N may describe an endpoint of the API 108, a path to the endpoint of the API 108, and/or an action or operation to be performed at the API 108. In some examples, each mapping 112-1 . . . 112-N may describe data associated with identifying and/or executing a REST call or REST command to the API 108.

Again, these mappings 112-1 . . . 112-N may be stored as a portion of the documentation configuration reference 102 of the API 108. That is, in contrast to other chatbots which may include objects created in the code of the chatbot itself that correspond to performance of actions at the API 108, the mappings 112-1 . . . 112-N may be a component of the documentation configuration reference 102 and/or the API 108.

As described above, the mappings 112-1 . . . 112-N may correspond to the regular expressions 110-1 . . . 110-N. In this manner, the documentation configuration reference 102 may include instructions to transform a natural language input 106 to a REST call without the expansion of the chatbot 104 instructions to include libraries with such information. However, to be utilized for such a purpose, the documentation configuration reference 102, and more specifically the regular expressions 110-1 . . . 110-N and their corresponding mappings 112-1 . . . 112-N may be exposed to the chatbot 104. As such, the chatbot 104 may be able to parse the documentation configuration reference 102 to identify or learn the regular expressions 110-1 . . . 110-N and their corresponding mappings 112-1 . . . 112-N for the API 108 that it is trying to communicate with on behalf of the user. In some example, the regular expressions 110-1 . . . 110-N and/or their corresponding mappings 112-1 . . . 112-N to the API resources may be set apart from the remainder of the documentation configuration reference 102.

For example, the regular expressions 110-1 . . . 110-N and/or their corresponding mappings 112-1 . . . 112-N to the API resources may be set apart from the body of the documentation configuration reference 102 by a symbol such that a human user and/or a computing device can identify and/or segregate the regular expressions 110-1 . . . 110-N and/or their corresponding mappings 112-1 . . . 112-N from the other information contained in the documentation configuration reference 102.

In some examples, the regular expressions 110-1 . . . 110-N and/or their corresponding mappings 112-1 . . . 112-N may be located in a portion of the documentation configuration reference 102 that is outside of a documentation tag. As such, the regular expressions 110-1 . . . 110-N and/or their corresponding mappings 112-1 . . . 112-N may not be visible to or accessible by a human user. However, the regular expressions 110-1 . . . 110-N and/or their corresponding mappings 112-1 . . . 112-N may be visible to computing devices and/or to the chatbot 104.

As such, in the system 100 a chatbot 104 may receive a natural language input 106 from a user. The chatbot 104 may parse the documentation configuration reference 102 of an API 108 that the input 106 is directed to, calls on, and/or implicates. In some examples, the chatbot 104 may process the input 106 to determine which API 108 the input 106 is directed to. In some examples, the chatbot 104 may infer from the content or context of the input 106 which API 108 the input 106 is directed to. In some examples, the chatbot 104 may prompt and/or receive an indication from the user directly indicating the API 108 that the input 106 is directed to. In some examples, the chatbot 104 may parse the documentation configuration reference of a plurality of APIs to find a match to a regular expression in a particular one of the plurality of APIs that informs which API pf the plurality that the input 106 is directed to.

The chatbot 104 may parse the documentation configuration reference 102 of an API 108 that the input 106 is directed to in order to compare the natural language input 106 to the regular expressions 110-1 . . . 110-N declared in the documentation configuration reference 102. The chatbot 104 may parse the documentation configuration reference 102 of an API 108 to identify a regular expression 110-1 . . . 110-N that matches a portion of the natural language input 106.

The chatbot 104 may parse the documentation configuration reference 102 of an API 108 to identify a mapping 112-1 . . . 112-N that corresponds to the regular expression 110-1 . . . 110-N that matches a portion of the natural language input 106. For example, the chatbot 104 may parse the documentation configuration reference 102 of an API 108 and identify that a first regular expression 110-1 matches a portion of the natural language input 106 that the user input to the chatbot 104. The chatbot 104 may parse the documentation configuration reference 102 of an API 108 and identify a first mapping 112-1 that corresponds to the first regular expression 110-1 matching a portion of the natural language input 106. For example, the chatbot may identify a first mapping 112-1 that declares an API path and an API operation corresponding to the first regular expression 110-1. The API path may specify an endpoint resource exposed by the API 108. The API operation may include an HTTP and/or not HTTP method operation utilizable to access the API path.

The chatbot 104 may execute the action 114 declared in the first mapping 112-1 that corresponds to the first regular expression 110-1 that matches a portion of the natural language input 106. For example, the chatbot 104 may determine the URL or the path to an operation to be performed at an endpoint resource of the API 108 and may utilize the declared path to access the endpoint resource and execute the operation. The chatbot 104, in some examples, may not be relying on objects or libraries within its own instructions to identify regular expressions in the natural language input and/or to determine actions corresponding to those regular expressions. Instead, the chatbot 104 may be relying on a parsing of the documentation configuration reference 102 and, more specifically, the regular expressions 110-1 . . . 110-N and their corresponding mappings 112-1 . . . 112-N to determine how to connect, interface, and/or communicate with an API 108. As such, a chatbot 104 may be genericized insofar as the chatbot 104 may be able to communicate with an array of APIs and even new APIs without updating and/or extending the chatbot 104 instructions.

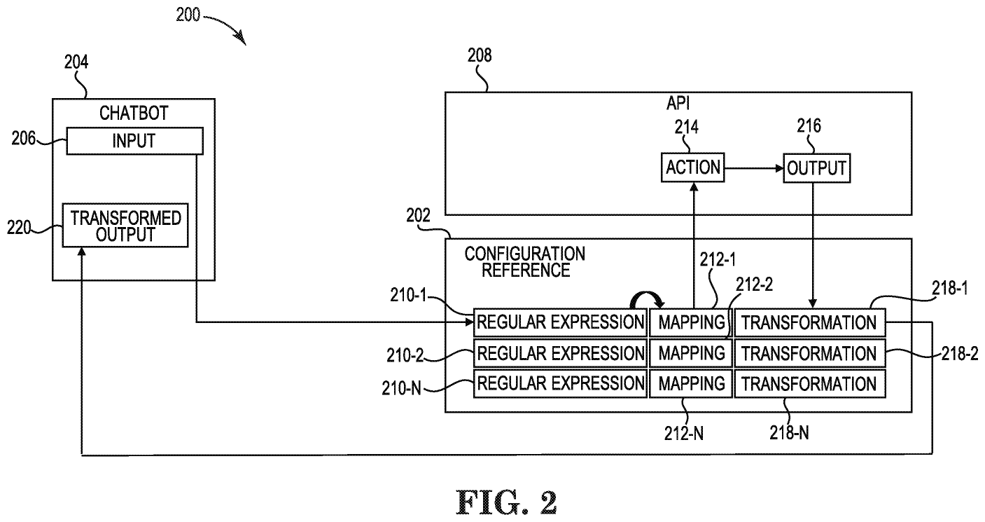

FIG. 2 illustrates an example of a system 200 of API documentation configuration reference 202 utilization consistent with the present disclosure. The system 200 may include a chatbot 104. The chatbot 204 may receive an input 206 from a user. The input 206 may include a request to the chatbot 104 to perform a digital assistance and/or data discovery operation on behalf of the user with a separate API 208.

The chatbot 204 may parse a configuration reference 202 of the API 208 in order to determine regular expressions 210-1 . . . 210-N and their corresponding mappings 212-1 . . . 212-N to endpoints, paths, resources, operations, etc. of the API 208. The chatbot 204 may parse the configuration reference 202 of the API 208 in order to identify regular expressions 210-1 . . . 210-N declared in the configuration reference 202 that match a portion of the natural language input 206.

The chatbot 204 may execute an action 214 according to a mapping 212-1 . . . 212-N declared by the configuration reference 202 of the API 208 as corresponding to the regular expression that it identified as matching the portion of the natural language input 206. For example, the chatbot 204 may utilize a path to an endpoint resource to access the endpoint and execute an operation on the endpoint as specified by the mapping 212-1 . . . 212-N. The chatbot 204 may be initially uninformed of the correlation between its received natural language input 206 and a regular expression 210-1 . . . 210-N recognized by the API 208. Likewise, the chatbot 204 may be initially uninformed of the correlation between the regular expression 210-1 . . . 210-N matching its input 206 and the corresponding mapping 212-1 . . . 212-N to an action 214 at the API 208. The chatbot 204 may not possess this data but may instead rely on the regular expressions 210-1 . . . 210-N and their corresponding mappings 212-1 . . . 212-N stored in the configuration reference 202 of the API 208 which may allow the chatbot 204 to interface with multiple diverse APIs without expansion of the chatbot 204 instructions.

In some examples, the action 214 performed at the API 214 may generate an output 216. For example, an action 214 such as a data query of a database resource of an API 208 may generate an output 216 including the response to the query (e.g., the queried for data). However, the output 216 may be in a wide variety of formats. For example, the output 216 may be produced by the API 208 in a format that is native to and/or utilized by the API 208. The output 216 may not be in a format displayable by and/or understandable by the chatbot 204. Additionally, the output 216 may not be in a format displayable to or understandable by the user of the chatbot 204. In some examples, the output 216 may be formatted in a structured or hierarchical language that is difficult for a human user to easily understand. The output 216 may not be formatted in a natural language format that corresponds to and responds to the natural language input 206 in a natural language and/or conversational manner. For example, execution of the action 214 at the API 208 may return data in a JSON, HTML, and/or other hierarchical data format. As such, the display of the output 216 in such a format by the chatbot 204 to the user may not be useful, efficient, and/or expected by the human user of the chatbot 204.

However, in addition to mappings 212-1 . . . 212-N that correspond to the regular expressions 210-1 . . . 210-N, the configuration reference 202 may additionally include transformations 218-1 . . . 218-N that correspond to the regular expressions 210-1 . . . 210-N and/or mappings 212-1 . . . 212-N. A transformation 218-1 . . . 218-N may declare instructions to transform an output 216 generated by an action 214 performed according to a corresponding mapping 212-1 . . . 212-N which corresponded to a particular regular expression 210-1 . . . 210-N that matched a portion of an input 206.

For example, a transformation 218-1 . . . 218-N may declare instructions for changing the format of an output 216 to a format utilized by the chatbot 204 and/or the user. For example, a transformation 218-1 . . . 218-N may include instructions on converting the output 216 to a natural language format for communication by the chatbot 204 to the user in a conversational natural language format.

In some examples, the transformation 218-1 . . . 218-N for a particular regular expression 210-1 . . . 210-N and/or mapping 212-1 . . . 212-N may include instructions on how to transform the corresponding output 216 into a plurality of distinct formats (e.g., natural language, different dialects, different structure languages, different hierarchical languages, different file types, etc.). The particular transformation 218-1 . . . 218-N utilized to transform the output 216 may be determined by the chatbot 204, the user of the chatbot 204, and/or the format of the input 206 to the chatbot 204.

The chatbot 204 may transform the output 216 according to the transformation 218-1 . . . 218-N that corresponds to the mapping 212-1 . . . 212-N which corresponds to the regular expression 210-1 . . . 210-N that the chatbot 204 determined to match a portion of its input 206. The transformed output 220, including the data from the output 216 transformed into the specified format, may be presented to the user by the chatbot 204 via a user interface and/or audio output.

In some examples, creating the transformed output 220 may involve placing portions of the output 216 in an approximation of a natural language sentence addressed to the user. In some examples, creating the transformed output 220 may involve calculating and/or otherwise determining new data from the output 216 and/or placing the new data in an approximation of a natural language sentence addressed to the user. For example, creating the transformed output 220 may involve summing an amount of outputs and placing the sum in a natural language sentence addressed to the user.

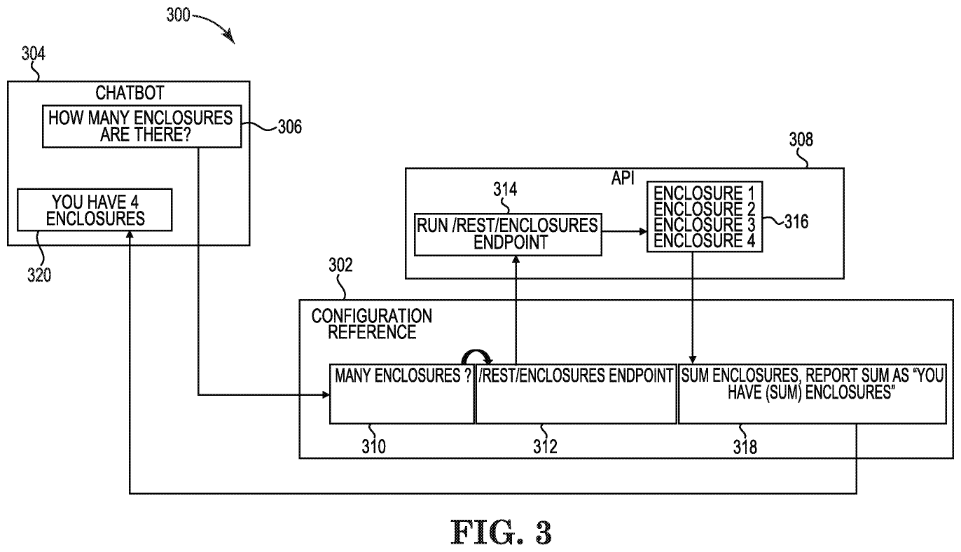

FIG. 3 illustrates an example of a system 300 of API documentation configuration reference 302 utilization consistent with the present disclosure. The system 300 may include a chatbot 304. The chatbot 304 may be utilized as a digital assistant for interfacing with IT management APIs. The chatbot 304 may receive input an input 306 form a user.

The input 306 may include an input 306 structured in a natural language format. For example, the input 306 may include a natural language sentence including a data inquiry formatted in a natural language sentence that is directed to an API 308 that is separate from the chatbot 304. In an example, the input 306 may include the natural language sentence “HOW MANY ENCLOSURES ARE THERE?”.

The chatbot 304 may parse the configuration reference 302 of the API 308 that the input 306 is directed to. For example, the chatbot 304 may parse the configuration reference 302 of the API 308 where the data that answers the query included in the input 306 may be discovered. The chatbot 304 may parse the configuration reference 302 of the API 308 to identify a regular expression 310, saved in the configuration reference 302, that matches a portion of the input 306. For example, the chatbot 304 may identify that a regular expression “MANY. ENCLOSURES.?” matches the “MANY” “ENCLOSURES” and “?” characters of the natural language input 306 “HOW MANY ENCLOSURES ARE THERE?”. The chatbot 304 may identify the regular expression 310 as a match to the input 306.

In parsing the configuration reference 302, the chatbot 304 may identify a mapping 312 that corresponds to the regular expression 310 determined to match a portion of the input 306. The mapping 312 may specify a REST call corresponding to the regular expression 310. For example, the mapping 312 may declare an endpoint, a path, and/or an operation to be performed to the API 308. For example, the chatbot 304 may determine that the mapping 312 “/REST/ENCLOSURES ENDPOINT” corresponds to the regular expression 310 “MANY. ENCLOSURES.?”.

The chatbot 304 may execute the instructions declared in the mapping 312 to perform an action 314 to the API 308. For example, the chatbot 304 may perform an action 314 by executing “RUN/REST/ENCLOSURES ENDPOINT” to the API 308.

In executing the action 314, an output 316 may be generated through the API 308. For example, executing “RUN/REST/ENCLOSURES ENDPOINT” may generate an output 316 including a listing of the active enclosures in a data center. For example, the output 316 may include a listing of active enclosures such as “ENCLOSURE 1, ENCLOSURE 2, ENCLOSURE 3, ENCLOSURE 4” in addition to some status information about each enclosure. However, the output 316 may not be in a format that the chatbot 304 may be configured to communicate to a user.

In parsing the configuration reference 302, the chatbot 304 may identify a transformation 318 that corresponds to the mapping 312 and/or the regular expression 310 determined to match the portion of the input 306. The transformation 318 may declare instructions to transform the output 316 to a format that the chatbot 304 may utilize to communicate to the user. For example, the transformation 318 may include instructions to transform the output 316 to an approximation of a natural language response to the input 306. In an example, the transformation 318 may declare instructions to “SUM ENCLOSURES, REPORT SUM AS “YOU HAVE (SUM) ENCLOSURES”.”

The chatbot 304 may utilize the transformation 318 to transform the output 316 into a transformed output 320. For example, the chatbot 304 may sum the four enclosures reported in the output 316. The chatbot 304 may insert the sum into the natural language sentence specified in the transformation 318. The resulting transformed output 320 may read “YOU HAVE 4 ENCLOSURES.” The chatbot 304 may communicate the transformed output 320 to the user via a user interface of the chatbot 304.

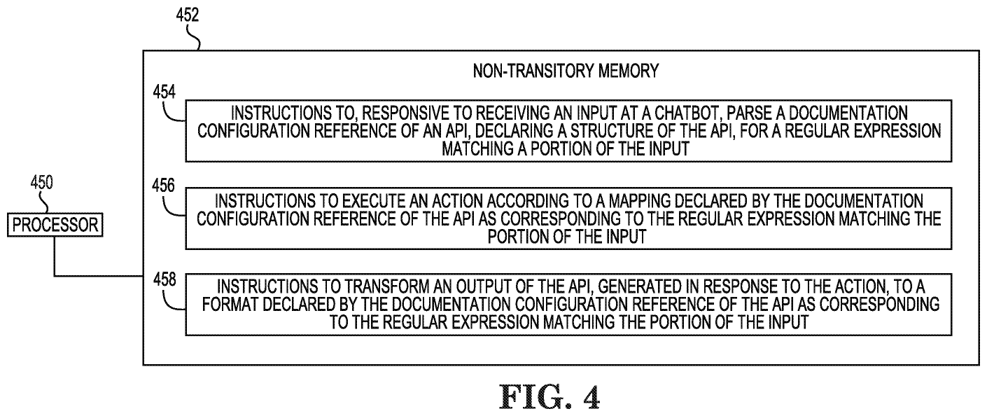

FIG. 4 illustrates an example of a non-transitory machine-readable memory resource and processing resource for API documentation configuration reference utilization consistent with the present disclosure. The processing resource 450, and the non-transitory memory resource 452, illustrated in FIG. 4 may be analogous to the elements illustrated in FIGS. 1, 2, and 3. A memory resource, such as the non-transitory memory resource 452, may be used to store instructions (e.g., 454, 456, 458, etc.) executed by the processing resource 450 to perform the operations as described herein. The operations are not limited to a particular example described herein and may include additional operations such as those described with regard to the system 100, system 200, system 300, and the method 580 described in connection with FIGS. 1, 2, 3, and 5.

The non-transitory memory resource 452 may store instructions 454 executable by the processing resource 450 to receive an input from a user at a chatbot. The user input may be a structured as a natural language sentence. Responsive to receiving the input, the chatbot may parse a documentation configuration reference of an API.

The documentation configuration reference may be a component of the API. The documentation configuration reference of the API may include instructions separate from and/or outside of the instructions comprising the chatbot. That is, the chatbot and the API and/or its API documentation configuration reference may be separate sets of instructions.

However, the documentation configuration reference of the API may be accessible to the chatbot. For example, the documentation configuration reference may be exposed to the chatbot and able to be parsed by the chatbot. For example, the chatbot may be configured to analyze the documentation configuration reference and the documentation configuration reference may be configured to be parsed by the chatbot.

The documentation configuration reference may include a catalog of language features that may be utilized to interface with the API. For example, the documentation configuration reference may include a listing of regular expressions that may be utilized with the API.

The chatbot may, responsive to receiving the input, parse the documentation configuration reference of an API for a regular expression that matches a portion of the input received by the chatbot. That is, the chatbot may search the regular expressions stored in the documentation configuration reference of an API for a regular expression that matches a portion of the input that the chatbot has received.

In some examples, a documentation configuration reference of a plurality of documentation configuration references corresponding to a plurality of APIs may be selected for parsing. The chatbot may determine which of the plurality of documentation configuration references of the plurality of APIs to be parsed for a regular expression matching a portion of a particular input based on an indication, received at the chatbot, of an API that the particular input is directed to. For example, the input of the user may include a designation of the API that the user input is directed to. In some examples, the chatbot may query a user, responsive to receiving an input, as to which API the user wishes the chatbot to direct the query.

In addition to identifying a regular expression in the documentation configuration reference of the API that matches a portion of the input received at the chatbot, the chatbot may identify a mapping, also saved in the documentation configuration reference of the API, that corresponds to the matching regular expression. That is, the documentation configuration reference may include mappings. The mappings may correspond to specific regular expressions stored in the documentation configuration reference. The mappings may, for example, declare instructions for accessing an endpoint of the API and/or actions to be performed at the endpoints. The regular expressions may be tied to specific queries, commands, etc. that may be applicable to and/or performed at the API. The mappings may include instructions on how to execute those specific queries, commands, etc. The mappings may specify a path to an applicable endpoint resource exposed by the API and/or an API utilizable to access the API path. For example, the API may be a REST API (e.g., based on a representational state transfer software architectural style) and the mappings may include the instructions for utilizing a REST call to the API to perform an action requested by the input as determined by its match to a regular expression.

The non-transitory memory resource 452 may store instructions 456 executable by the processing resource 450 to execute an action at the API. The action may be executed according to the mapping declared by the documentation configuration reference of the API as corresponding to the regular expression that matched the portion of the input received at the chatbot. The action may be executed by the chatbot. The chatbot may execute the instructions included in the mapping that corresponds to the matching regular expression. For example, the chatbot may execute the REST call, specified in the mapping, to the API to perform an operation at an endpoint exposed by the API.

Execution of the action at the API may cause the API to generate an output. The output may be generated in a format that is native to the API. Since the API and the chatbot may be wholly distinct applications, the format native to outputs for the API may not be an appropriate format for the chatbot to output to the user. In some examples, the output may include raw data which includes more information or less information than a user is requesting. In some examples, the output may be organized in a format that does not fully address the input or involves additional processing to arrive at a response that fully addresses the input.

The non-transitory memory resource 452 may store instructions 458 executable by the processing resource 450 to transform the output of the API generated in response to the executed action. The transformation may be performed according to a transformation declared by the documentation configuration reference of the API as corresponding to the regular expression matching the portion of the input. That is, the regular expression that matches the portion of the input to the chatbot may correspond to a specific mapping and to a specific transformation. The mapping may include the instructions to perform the action. The transformation may include instructions to convert, by the chatbot, the output of the API to a sentence readable by a human user and/or structured to address a query included in the input to the chatbot.

Transforming the output of the API may include changing the format, the content, the structure, and/or the communication medium of the data output by the API to be communicated by the chatbot to the user. In some examples, data may be extracted and/or calculated from the output of the API and structured into an approximation of a natural language sentence that provides a conversational-style response to the input received at the chatbot. Having transformed the output, the chatbot may communicate the transformed output to the user.

In addition, the chatbot may parse a second documentation configuration reference of a second API. The chatbot may identify a second regular expression matching a portion of the input to the chatbot. The chatbot may execute a second action at the second API. The chatbot may execute the second action according to a second mapping. The second mapping may be a second mapping declared by the second documentation configuration reference of the second API as corresponding to the second regular expression matching the portion of the input. The chatbot may transform a second output of the API that is generated in response to the second action. The transformation may be performed according to a second transformation declared by the second documentation configuration reference of the second API as corresponding to the second regular expression matching the portion of the input.

As such, the chatbot may parse the documentation configuration references of and/or interface with a plurality of distinct APIs. Therefore, without expansion of the instructions comprising the chatbot to include regular expressions, mappings, and/or transformations, the chatbot may fluidly communicate across the diverse APIs to translate its input into an action unique to each of the distinct APIs and transform a unique response back from the API to a format consistent with the operation of the chatbot.

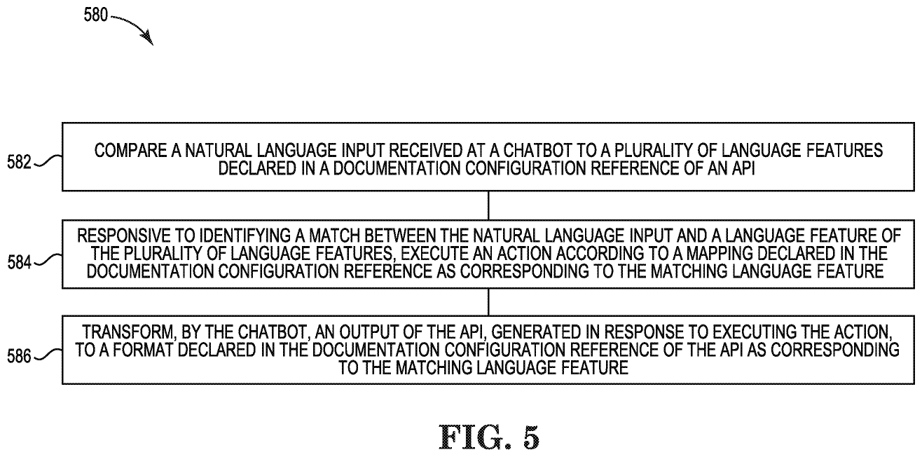

FIG. 5 illustrates an example of a method 580 for API documentation configuration reference utilization consistent with the present disclosure. At 582, the method 580 may include receiving a natural language input at a chatbot. The natural language input may include a command and/or a query to be submitted to an API by the chatbot on behalf of the user. The command and/or query may be submitted as a natural language question that implicates data and/or services of an API.

The chatbot may parse a documentation configuration reference of an API. The documentation configuration reference of the API may include language features that correspond to a mapping and/or a transformation. For example, the documentation configuration reference may include a language feature such as a regular expression and/or any other type of structure or analysis that may identify the content or context of a natural language input. A mapping that corresponds to the language feature may declare instructions to execute an action at the API that corresponds to the regular expression. The transformation that corresponds to the language feature may include instructions to transform an output resulting from executing the action to a transformed output reformatted for communication by the chatbot to a user issuing the input.

In parsing the documentation configuration reference of the API, the chatbot may compare the natural language input it has received to a plurality of language features declared in the documentation configuration reference of the API. The chatbot may identify a match between a language feature declared in the documentation configuration reference of the API and a portion of the natural language input that the chatbot received.

At 584, the method 580 may include the chatbot executing an action at the API responsive to identifying the match between the natural language input and the language feature of the plurality of language features declared in the documentation configuration reference of the API.

The action may be executed by the chatbot according to the mapping declared in the documentation configuration reference as corresponding to the matching language feature. For example, the chatbot may utilize a path specified in the corresponding mapping to access an applicable endpoint resource exposed by the API and/or to instruct performance of an operation at the endpoint.

At 586, the method 580 may include transforming, by the chatbot, an output of the API that was generated in response to execution of the action by the chatbot. Transforming the output may include changing the format of the output from a format native to the API that generated the output to a format declared in the documentation configuration reference of the API as corresponding to the matching language feature. For example, transforming the output may include utilizing the output to perform a mathematical operation and placing the output of the mathematical operation into a natural language sentence structure format. Thereafter, the transformed output may be displayed to the user via the chatbot. The user may be prompted for further input after displaying the transformed output. For example, the user may be asked whether they have additional request and/or may be suggested additional requests related to their previous input.

The documentation configuration references of the API may be extended and/or otherwise modified to include the aforementioned plurality of language features, mappings corresponding to each of the plurality of language features, and/or transformation output formats corresponding to each of the plurality of language features. The documentation configuration references of the API may be exposed to the chatbot such that the plurality of language features, mappings corresponding to each of the plurality of language features, and/or transformation output formats corresponding to each of the plurality of language features are parse-able by the chatbot. For example, special tags, symbols, characters, spacing, formatting, and/or other indicators may be utilized to highlight, reveal, and/or render the plurality of language features, mappings corresponding to each of the plurality of language features, and/or transformation output formats corresponding to each of the plurality of language features parse-able by a chatbot.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processing resource;
a memory resource storing machine-readable instructions to cause the processing resource to:
responsive to receiving an input at a chatbot, parse a documentation configuration reference of an API for a regular expression, declared in the API documentation configuration reference, matching a portion of the input; and
execute an action according to a mapping declared by the documentation configuration reference of the API as corresponding to the regular expression matching the portion of the input.

2. The system of claim 1, wherein the documentation configuration reference of the API declares the structure of the API.

3. The system of claim 1, wherein the documentation configuration reference of the API is a swagger documentation file.

4. The system of claim 1, wherein the declared mapping includes an API path and an API operation corresponding to the regular expression matching the portion of the input.

5. The system of claim 4, wherein the API path includes an endpoint resource exposed by the API.

6. The system of claim 5, wherein the API operation includes an HTTP method operation utilizable to access the API path.

7. The system of claim 5, wherein the instructions to execute the action include instructions to run the API operation at the API path to cause the API to generate an output.

8. The system of claim 1, wherein the regular expression and the mapping are included in a portion of the documentation configuration reference of the API set apart by a symbol and readable by the chatbot.

9. The system of claim 1, wherein the regular expression and the mapping are included in a portion of the documentation configuration reference of the API outside of a documentation tag and not visible by a human user.

10. A non-transitory machine-readable storage medium having stored thereon machine-readable instructions to cause a computer processor to:
responsive to receiving an input at a chatbot, parse a documentation configuration reference of an API, with the chatbot, for a regular expression matching a portion of the input;
execute an action according to a mapping declared by the documentation configuration reference of the API as corresponding to the regular expression matching the portion of the input; and
transform an output of the API, generated in response to the action, according to a transformation declared by the documentation configuration reference of the API as corresponding to the regular expression matching the portion of the input.

11. The non-transitory machine-readable medium of claim 10, wherein the documentation configuration reference of the API is accessible to the chatbot and is outside the instructions comprising the chatbot.

12. The non-transitory machine-readable medium of claim 10, wherein the transformation declared by the documentation configuration reference of the API includes instructions to convert, by the chatbot, the output of the API to a sentence readable by a human user and structured to address a query included in the input to the chatbot.

13. The non-transitory machine-readable medium of claim 10, including instructions executable by the processor to determine which of a plurality of documentation configuration references of a plurality of APIs is to be parsed for a particular input based on an indication, received at the chatbot, of an API that the particular input is directed to.

14. The non-transitory machine-readable medium of claim 10, including instructions executable by the processor to:
parse a second documentation configuration reference of a second API, with the chatbot, for a second regular expression matching a portion of the input;
execute a second action at the second API according to a second mapping declared by the second documentation configuration reference of the second API as corresponding to the second regular expression matching the portion of the input; and
transform a second output of the second API, generated in response to the second action, according to a second transformation declared by the second documentation configuration reference of the second API as corresponding to the second regular expression matching the portion of the input.

15. The non-transitory machine-readable medium of claim 10, wherein the documentation configuration reference of the API is a component of the API.

16. The non-transitory machine-readable medium of claim 10, wherein the API is a REST API and wherein to execute the action according to the mapping includes utilizing a REST call to the API declared as corresponding to the regular expression matching the portion of the input.

17. A method, comprising:
comparing a natural language input received at a chatbot to a plurality of language features declared in a documentation configuration reference of an API;
responsive to identifying a match between the natural language input and a language feature of the plurality of language features, executing an action according to a mapping declared in the documentation configuration reference as corresponding to the matching language feature; and
transforming, by the chatbot, an output of the API, generated in response to executing the action, to a format declared in the documentation configuration reference of the API as corresponding to the matching language feature.

18. The method of claim 17, wherein transforming the output of the API includes utilizing the output to perform a mathematical operation and placing an output of the mathematical operation into a sentence structure format.

19. The method of claim 17, including displaying the transformed output to a user via the chatbot and prompting the user for further input.

20. The method of claim 17, including:
modifying the documentation configuration reference of the API to include the plurality of language features, mappings corresponding to each of the plurality of language features, and output formats corresponding to each of the plurality of language features; and
exposing the plurality of language features, the mappings corresponding to each of the plurality of language features, and the output formats corresponding to each of the plurality of language features to be parse-able by the chatbot.
